(19) United States
(12) Patent Application Publication
(10) Pub. No.: US 2008/0014786 A1
(43) Pub. Date: Jan. 17, 2008

(54) BULK POWER ASSEMBLY ENGAGEMENT SYSTEM AND METHOD

(75) Inventors: William L. Brodsky, Binghamton, NY (US); Kevin R. Covi, Glenford, NY (US); Edward J. Seminaro, Milton, NY (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/457,571

(22) Filed: Jul. 14, 2006

(51) Int. Cl. H01R 13/72

(52) U.S. Cl. 439/501

(57) ABSTRACT

Disclosed herein is an engagement system for bulk power assemblies. The system comprising, a first bulk power assembly and a second bulk power assembly having equal numbers of electrical terminals and guide bosses. The system also having a rigid interface member having a first end and a second end, both ends having an equal number of terminal blades as there are electrical terminals on the first bulk power assembly and an equal number of guide blades as there are guide bosses on the first bulk power assembly. The terminal blades being receptive to make an electrical connection with the electrical terminals and the guide blades being receptive to engage with the guide bosses, in response to the interface member being functionally engaged with both bulk power assemblies simultaneously.

### TRADEMARKS

IBM® is a registered trademark of International Business Machines Corporation, Armonk, New York, U.S.A. Other names used herein may be registered trademarks, trademarks or product names of International Business Machines Corporation or other companies.

### BACKGROUND OF THE INVENTION

1. Field of the Invention

This invention relates to interconnecting bulk power assemblies, and particularly to electrical engagement of the interconnection.

2. Description of Background

Utilizing multiple bulk power assemblies requires interconnecting them for operability. All IBM high-end servers require a power supply it is also desirable to provide a backup power supply. The output of IBM's commercially available bulk power supplies was sufficient for IB3M's commercially available servers, therefore a single bulk power assembly as a primary source and a second as a backup source has been a convenient and efficient expectant for some time.

IBM's newer node-based clustered servers, however, exceeds the rating of a single bulk power assembly when more than about 12 nodes are installed. Therefore, for such large systems the combined power output of both the primary and the “backup” bulk power assemblies is required for normal operation, with an attendant loss of line-cord redumdancy. The loss of redundancy has been considered an acceptable trade-off in the high-performance computing marketplace to get the performance that a fall 16-node server provides.

For these large servers the outputs of the two bulk power assemblies must be electrically connected to supply twice the power rating of a single bulk power assembly. Since, however, each bulk power assembly consists of three independent bulk power regulators, some measure of redundancy can be retained by rating the total system power for 2N-1 times the rating of each bulk power regulator, where N represents the power rating of the bulk power regulator. In one previous approach the two bulk power assemblies were electrically connected by substituting a bulk power jumper card for a bulk power distribution card in each bulk power assembly and a single high-current cable was plugged into each bulk power jumper to complete the connection. There are several drawbacks associated with such an arrangement: a card slot is required for the jumper card, each jumper card requires two connectors (backplane and cable connections) at a significant cost, the required cable also adds cost to the design, room inside the system cage is required to rout the cable with its associated bend radius, and the connectors limit the maximum current to 60 amps, which will be insufficient to power the new higher performance servers.

Accordingly, there is a need for a simple and cost effective way to electrically connect bulk power supplies together with high current handling capabilities.

### SUMMARY OF THE INVENTION

The shortcomings of the prior art are overcome and additional advantages are provided through the provision of an engagement system for bulk power assemblies. The system comprising, a first bulk power assembly having a plurality of electrical terminals and at least one guide boss on a surface thereof, a second bulk power assembly having an equal number of electrical terminals as there are electrical terminals of the first bulk power assembly and an equal number of guide bosses to the number of guide bosses of the first bulk power assembly on a surface thereof. And a rigid interface member having a first end and a second end, both ends having an equal number of terminal blades as there are electrical terminals on the first bulk power assembly and an equal number of guide blades as there are guide bosses on the first bulk power assembly. The terminal blades being receptive to make an electrical connection with the electrical terminals and the guide blades being receptive to engage with the guide bosses, in response to the interface member being functionally engaged with both bulk power assemblies simultaneously.

Further advantages are provided through the provision of a method of engaging bulk power assemblies together. The method comprising, engaging a plurality of electric terminals of a first bulk power assembly with a plurality of male terminals of a first end of an interface member, and engaging a plurality of electric terminals of a second bulk power assembly with a plurality of male terminals of a second end of the interface member. The engagement resulting from compressing the rigid interface member between the two bulk power assemblies.

Systems and methods corresponding to the above-summarized systems and methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a server system disclosed herein;

FIG. 2 illustrates one example of a top view of bulk power assemblies disclosed herein;

FIG. 3 illustrates one example of a perspective view of a bulk power assembly disclosed herein;

FIG. 4 illustrates one example of a section view of two bulk power assemblies in functional engagement disclosed herein;

FIG. 5 illustrated one example of a perspective view of an interface member disclosed herein; and

FIG. 6 illustrates one example of a cover disclosed herein.

The detailed description explains the preferred embodiments of the invention, together with advantages and features, by way of example with reference to the drawings.

### DETAILED DESCRIPTION OF THE INVENTION

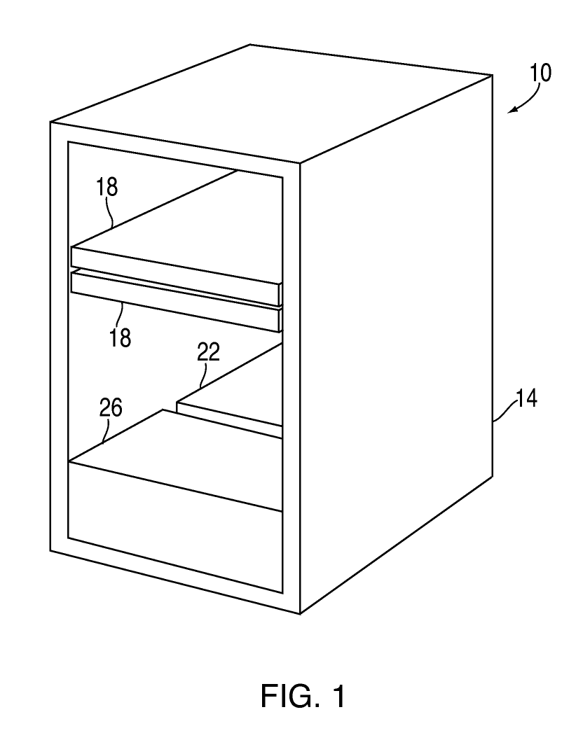

Turning now to the drawings in greater detail, it will be seen that in FIG. 1 there is a server system shown generally at 10. The server system 10 comprises a rack 14 that structurally holds the components of the system 10 in relation to one another. For example, multiple processor units 18 mount in a one above the other stacking fashion inside the rack 14 while a first bulk power assembly 22 and a second bulk power assembly 26 are positioned near an inside lower surface of the rack 14.

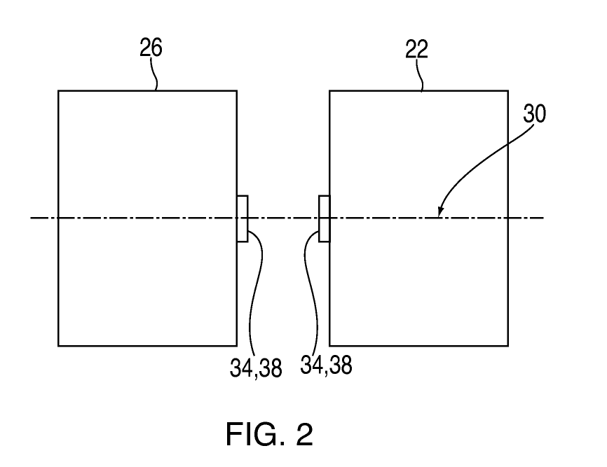

Referring to FIG. 2 the bulk power assemblies 22, 26 are shown from above with a centerline 30 drawn through the centers of both bulk power assemblies 22, 26. Guide bosses 34 and terminal bosses 38 on both bulk power assemblies 22, 26 are aligned along the centerline 30 and will be described in more detail below.

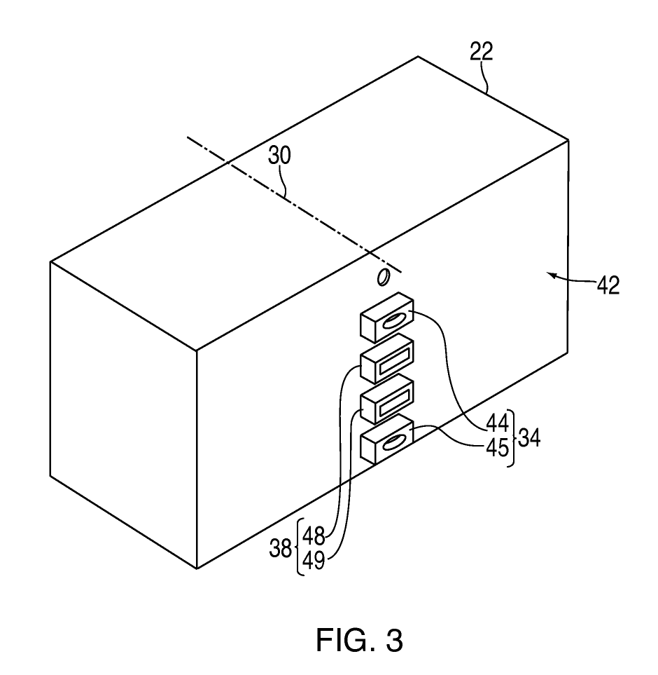

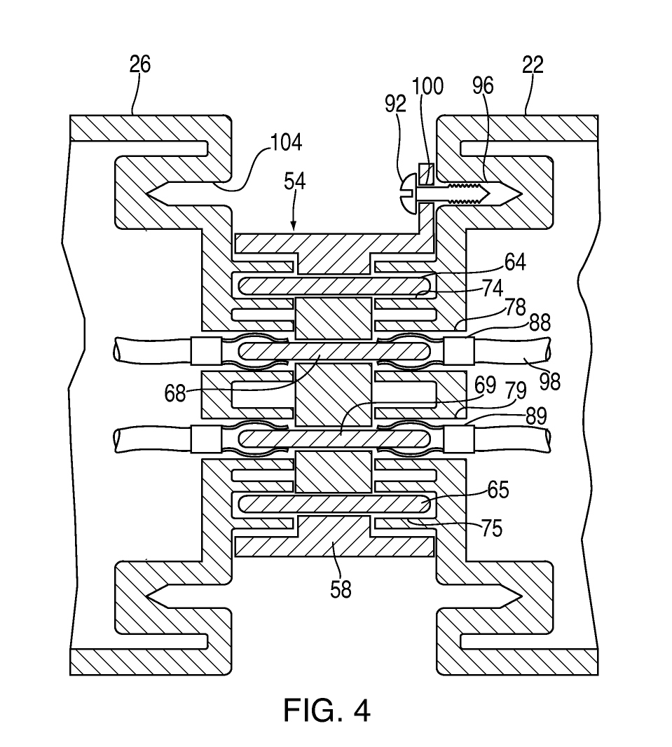

Referring to FIG. 3 a perspective view of the first bulk power assembly 22 shows the guide bosses 34 and the terminal bosses 38 in more detail. The bosses 34, 38 all protrude from a back plane 42, which forms one surface of the bulk power assembly 22. The bosses 34, 38 are aligned along the centerline 30 of the bulk power assembly 22 in a vertical direction. It should be noted that in other embodiments the bosses 34, 38 could be aligned in other orientations, directions and relationships to one another while still remaining within the scope and spirit of the present invention. An upper guide boss 44 and a lower guide boss 45 comprise the guide bosses 34 of the first bulk power assembly 22. Similarly, an upper terminal boss 48 and a lower terminal boss 49 comprise the terminal bosses 38 of the first bulk power assembly 22. All four bosses 44, 45, 48, 49 include an opening that will be described in more detail in reference to FIG. 4. It should be noted that the second bulk power assembly 26 is substantially identical to the first bulk power assembly 22 for purposes of embodiments disclosed herein and therefore to avoid repeating detailed descriptions will not be described in detail.

Referring to FIG. 4 a cross sectional view of the first bulk power assembly 22 is shown in electrical engagement with the second bulk power assembly 26 through a rigid interface member 54, sandwiched therebetween. The interface member 54 includes an injection molded, plastic nonconductive housing 58, an upper guide blade 64, a lower guide blade 65, upper terminal blade 68, and a lower terminal blade 69. The blades 64, 65, 68, 69 may be pressed into holes formed in the housing 58 and held in place by friction or by a detent, not shown, or insert molded into the housing 58 during the molding of the housing 58. Alternatively, the guide blades 64, 65 could be plastic and molded as part of the housing 58, thereby eliminating two separate components. The terminal blades 68, 69, on the other hand, cannot be molded as part of the housing 58 since they need to be conductive to complete the circuit with the bulk power assemblies 22, 26.

The positioning and orientation of the blades 64, 65 68, 69 of the interface member 54 must match the positioning and orientation of the bosses 44, 45, 48, 49 on the bulk power assemblies 22, 26 in order to assure they engage properly. The guide blades 64, 69 slidably engage with holes 74, 75 in the alignment bosses 44, 45 to align and pilot the interface member 54 with the bulk power assemblies 22, 26 prior to the terminal blades 68, 69 engaging with holes 78, 79 in the terminal bosses 48, 49. Such alignment assures that the upper terminal blade 68 engages with the an upper female terminal 88 located within the hole 78, and the lower terminal blade 69 engages with a lower female terminal 89 located within the hole 79. To assure the guide blades 64, 65 engage with the alignment bosses 44, 45 before the terminal blades 68, 69 engage with the terminal bosses 48, 49 the lengths of the guide blades 64, 65 are longer than the lengths of the terminal blades 68, 69. The ends of the guide blades 64, 65 are radiused, or alternatively chamfered, to allow for some misalignment of the guide blades 64, 65 with the holes 74, 75 at initial contact.

The upper terminal boss 48 of the first bulk power assembly 22 has an upper female terminal 88 connected to a wire 98, a lead frame, or other electrical circuit component within the bulk power supply 22 which has a positive electrical potential. The terminal 88 is positioned substantially in the center of the hole 78 and is slightly recessed from the surface 42. The terminal 88 is held in position relative to the housing 58, by common methods, so as to allow the terminal blade 68 to frictionally engage into the terminal 88 resulting in a reliable electrical connection between the blade 68 and the terminal 88. The lower terminal boss 49 as well as the terminal bosses of the second bulk power assembly 26 each has female terminals housed therein for similar electrical connections to their respective terminal blades. In order to properly connect the bulk power assemblies 22, 26 together in parallel the polarity of the upper terminals in both bulk power assemblies 22, 26 should be positive and the lower terminals in both bulk power assemblies 22, 26 should be negative.

In order to prevent the interface member 54 from disconnecting from both bulk power assemblies 22, 26 in the event that the second bulk power assembly 26 is removed from the rack 14 while the first bulk power assembly 22 is left in the rack 14, for example, the interface member 54 is attached to one of the bulk power assemblies 22, 26. To attach the interface member 54 to the first bulk power assembly 22, as shown, a fastener 92, disclosed herein as a screw, is threadably engaged with a hole 96 in the bulk power assembly 22 through a clearance hole 100 in the housing 58. Since the back plane connection details on the first bulk power assembly 22 are substantially identical to those on the second bulk power assembly 26, the interface member 54 can just as easily be fastened to the second bulk power assembly 26. To do so, rotate the interface member 54 by rotating the by 180 degrees to align the hole 100 with a hole 104 in the second bulk power assembly 26, and threadably engage the fastener 92 to the hole 104.

In the case described above, wherein the second bulk power assembly 26 has been removed from the rack 14 and the first bulk power assembly 22 remains in the rack 14 with the interface member 54 thereattached, it is possible for the server system to be powered up. In such an instance the terminal blades 68, 69 will have electrical potential applied thereon. Such electrical potential may be as high as 350 volts direct current, for example. With bulk power assemblies 22, 26 capable of supplying as much as 150 amps of current a dangerous situation exists with the possibility that a conductor could come in contact, simultaneously, with both exposed terminal blades 68, 69.

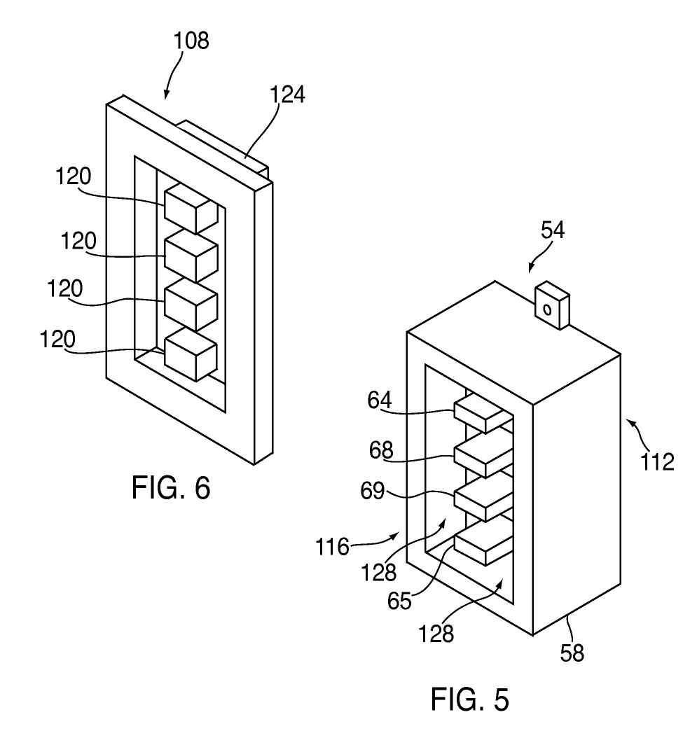

Referring now to FIGS. 5 and 6 an embodiment of the invention includes a cover 108 for frictionally engaging with either a first end 112 or a second end 116 of the interface member 54. For example, if the first end 112 is functionally engaged with the first bulk power assembly 22, which may be electrically powered up, the cover 108 can be applied to the second end 116 of the interface member 54 thereby providing an electrically insulative shield over the exposed terminal blades 68, 69. The cover 108 itself may be injection molded from a nonconductive plastic with features for attachment to the bulk power assemblies 22, 26 integrally formed thereon. Such features could include, for example, holes, not shown, molded within projections 120 that are sized to frictionally engage with the guide blades 64, 65 or the terminal blades 68, 69. Alternately, a rectangular shaped surface 124 of the cover 108 could frictionally engage with inner surfaces 128 of the housing 58 to removably attach the cover 108 to the interface member 54. Additionally, fasteners, not shown, could be employed to attach the cover 108 to the interface member 54 if more positive attachment is desired.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

1. An engagement system for bulk power assemblies, comprising:
a first bulk power assembly having a plurality of electrical terminals and at least one guide boss on a surface thereof;
a second bulk power assembly having a number of electrical terminals equal to the number of electrical terminals of the first bulk power assembly and a number of guide bosses equal to the number of guide bosses of the first bulk power assembly on a surface thereof;
a rigid interface member having a first end and a second end, each of the first end and the second end having a number of terminal blades matching the number of electrical terminals on the first bulk power assembly and a number of guide blades matching the number of guide bosses on the first bulk power assembly, the terminal blades being receptive to make electrical connection with the electrical terminals and the guide blades being receptive to engage with the guide bosses, such that the first bulk power assembly and the second bulk power assembly are in electrical communication with one another in response to the interface member being functionally engaged with the first bulk power assembly on one of the first end and the second end and the second bulk power assembly with the other of the first end and the second end that is not functionally engaged with the first bulk power assembly, the rigid interface member being selectively attachable to one of the first bulk power assembly and the second bulk power assembly without being attached to the other of the first bulk power assembly and the second bulk power assembly.

2. The engagement system of claim 1, wherein the electrical terminals of the first bulk power assembly and the second bulk power assembly are female and the terminals blades of the interface member are male.

3. The engagement system of claim 1, wherein the engagement includes establishing electrical communication of a positive terminal of the first bulk power assembly with a positive terminal of the second bulk power assembly and establishing electrical communication of a negative terminal of the first bulk power assembly with a negative terminal of the second bulk power assembly.

4. The engagement system of claim 1, wherein the first bulk power assembly has two terminals and two guide bosses stacked substantially in vertical alignment and the second bulk power assembly has two terminals and two guide bosses stacked substantially in vertical alignment and the interface member has two terminal blades and two guide blades stacked substantially in vertical alignment on both the first end and the second end and the interface member being receptive to creating the engagement of the first bulk power assembly with the second bulk power assembly in response to being sandwiched between the first bulk power assembly and the second bulk power assembly.

5. The engagement system of claim 1, further comprising a fastener for selectively attaching the interface member to one of the first bulk power assembly and the second bulk power assembly.

6. The engagement system of claim 1, further comprising an electrically insulative cover for attachment over the first end or the second end of the interface member.

7. A method of engaging bulk power assemblies together, comprising:
engaging a plurality of female electric terminals of a first bulk power assembly with a plurality of male terminals of a first end of a rigid interface member;
attaching the rigid interface member to one of the first bulk power assembly and the second bulk power assembly by applying a fastener through the rigid interface member into the bulk power assembly without attaching the rigid interface member to the other of the first bulk power assmebly and the second bulk power assembly;
engaging a plurality of female electric terminals of a second bulk power assembly with a plurality of male terminals of a second end of the rigid interface member; by
sandwiching the rigid interface member between the first bulk power assembly and the second bulk power assembly.

8. (canceled)

9. The engagement system of claim 5, wherein the fastener is a screw.
